(19) United States
(12) Patent Application Publication
(10) Pub. No.: US 2008/0222573 A1
(43) Pub. Date: Sep. 11, 2008

(54) Computer mouse with cursor finding function and faster screen privacy function

(76) Inventor: Simon Abeckaser, Brooklyn, NY (US)

Correspondence Address: Steven Horowitz;Counselor At Law, Suite 700, 295 Madison Avenue, New York, NY, 10017, US

(21) Appl. No.: 11/714,382

(22) Filed: Mar. 6, 2007

(51) Int. Cl. G06F 3/048

(52) U.S. Cl. 715/856

(57) ABSTRACT

A computer pointing device has a first additional button that jumps a cursor off the screen to the START button. The second additional button protects the privacy of screen content by instantly moving the cursor to the minimize box of the most recently opened window. When multiple child windows are open, in cascade or tile format, pressing again on the second button instantly moves the cursor to the second most recently opened window. If the child windows are in cascade format, that second most recently opened window jumps to the foreground with the cursor at the minimize box. Further pressing the second button moves the cursor to the third most recently opened window. If there are three buttons and a fourth press of the second button is made, the cursor moves back to the most recently opened child window and, if in cascade format, that window returns to the foreground.

### FIELD OF THE INVENTION

The present invention is in the field of computer pointing devices, and more particularly, relates to methods and apparatuses of enhancing the functionality of cursor-location and speeding the manipulation of windows on the computer screen.

### BACKGROUND OF THE INVENTION AND DISCUSSION OF THE PRIOR ART

Arguably the most common example of a computer pointing device is a computer mouse. The computer mouse converts the motion of the user's hand into computer signals. In the case of a track-ball mouse, a ball inside it touches the mouse pad on the desktop and rolls when the mouse moves. Two rollers inside the mouse touch the ball. One of the rollers is oriented so that it detects motion in the horizontal direction, and the other is oriented 90 degrees to the first roller so it detects motion in the vertical direction. When the ball rotates, one or both of these rollers rotate as well. Each of the rollers is connected to a shaft that spins an optical encoding disk with holes around its outer edge. When a roller rolls, its shaft and disk spin. On either side of the disk there is an infrared LED and an infrared sensor. The holes in the disk break the beam of light coming from the LED so that the infrared sensor sees pulses of light. The rate of the pulsing is directly related to the speed of the mouse and the distance it travels. A processor chip reads the pulses from the infrared sensors, turns them into binary data (bytes) and then sends the binary data to the computer.

An optical computer mouse uses a tiny camera to take thousands of pictures every second. A small, red light-emitting diode (LED) bounces light off that surface onto a complimentary metal-oxide semiconductor (CMOS) sensor. The CMOS sensor sends each image to a digital signal processor for analysis. The digital signal processor detects patterns in the images and examines how the patterns have moved since the previous image. Based on the change in patterns over a sequence of images, the digital signal processor determines how far the mouse has moved and sends the corresponding coordinates to the computer. The computer moves the cursor on the screen based on the coordinates received from the mouse. This happens hundreds of times each second, making the cursor appear to move very smoothly.

Several problems arise when using a computer pointing device and in general when using a computer screen. The first problem is that when using a computer mouse often the cursor disappears off the screen and it takes some time to get it back onto the screen. This can happen, for example, when the ball of a track-ball mouse interacts with dust on the mouse pad which distorts the ability of the mouse to convert the movement of the ball into movement of the cursor.

A second unrelated problem is when working at a computer screen on something private or highly confidential, if someone suddenly enters the room or a location from which the screen can be seen, it is greatly desirable to be able to conceal visibility of the work on the screen, to do so quickly, to do so quietly without the visitor knowing that you are doing so and to do so in a manner that allows for easy re-access to the same work when the “threat” is lifted. The operating system software for graphical user interface (including Windows® and Macintosh®) allows the user to minimize the screen displaying work being done by clicking on a small “minimize” box, typically near the top right corner of the window adjacent the Title Bar. So it is helpful to be able to quickly minimize the screen. Dragging the cursor to the minimize box so that one can then minimize the screen might take the extra second that you do not have to spare.

A third problem is that when you have two, three, four or many more, windows open at the same time and you are considering minimizing all or many of them, if the windows are not lined up one right behind the other exactly it can be inconvenient to move the cursor from the minimize box associated with one child window to the minimize box of a second or a third child window. Moreover, since dragging child windows requires grabbing the Title Bar of said child window, if you just want to move multiple child windows that are open, rather than minimize them, you have to move the cursor from the Title Bar of one child window to the Title Bar of each other child window. That can be inconvenient and take too long. There is a need for a more convenient way of navigating between multiple open child windows. Moreover, navigation through many computer screens, when repetitive, something that saves seconds or even fractions of seconds can make a material difference to the user.

The present invention provides solutions to all of the above problems as well as to other problems in a manner not taught by the prior art and provides advantages not taught in the prior art.

### SUMMARY OF THE PRESENT INVENTION

Preliminarily, it is noted that besides the computer mouse, other computer pointing devices include a trackball, a touchpad, a pointing stick, a lightpen, a joystick, an eye tracking device, a digitizing tablet that uses a stylus, a “data glove” that translates the user's movements to computer gestures and a Wii remote for a Nintendo® game. Accordingly, when used in this patent application, the term “computer pointing device” is intended to include not just a computer mouse but also the other pointing devices enumerated above. In light of this, when reference is made below to “clicking” or “pressing” in the context of a button or a surface area of a computer mouse, the present invention contemplates that analogous actions or activation words appropriate for other computer pointing devices are also intended and encompassed, unless from the context it is clear that this is not possible. Thus, activating the “activation areas” of other pointing devices other than a compute mouse is included.

In addition, the term “button” used in this patent application, for example used in the phrase “first button” 22 and the phrase “second button” 32, is a broad term that includes anything on a surface that is pushed, pressed or otherwise activated. It need not be shaped like a button or really resemble a button physically.

In summary, the computer pointing device of the present invention has two additional “buttons”. In the context of a computer mouse, these buttons are carved out of the top surfaces of the computer mouse, and ideally they form part of the left click and right click areas on the top surface of the mouse. The first additional button, when clicked or pressed or otherwise activated, immediately moves a cursor not visible on the screen to the START button. The second additional button protects the privacy of work on the screen by instantly moving the cursor, whether visible or not, to the minimize box of the most recently opened window. In addition, the second button allows navigation between multiple child windows. Accordingly, when multiple child windows are open on the computer screen, whether in cascade or tile format, pressing on the second button a second time instantly moves the cursor to the minimize box of the second most recently opened window. Further pressing on the second button moves the cursor to the minimize box of the third most recently opened child window, and so on. If the number of “presses” on the second button exceeds the number of child windows open, the cursor reverts to the minimize box of the most recently opened window.

If the child windows are in cascade format, when the second button is pressed the second time that second most recently opened window also jumps to the foreground with the cursor at the minimize box. Further pressing the second button moves the cursor to the third most recently opened window. If there are three buttons and a fourth press of the second button is made, the cursor moves back to the most recently opened child window and that window returns to the foreground.

### IMPORTANT OBJECTS AND ADVANTAGES

The following are important objects and advantages of the present invention:

(1) to provide a computer pointing device that can instantly bring a cursor that is off the computer screen back on to the screen;

(2) to provide a computer pointing device that can, with one click on the pointing device, place a cursor not visible on the screen at a defined section or field of the computer screen;

(3) to provide a computer pointing device that can, with one click on the pointing device, place a cursor not visible on the screen at the lower left hand portion of the screen;

(4) to provide a computer pointing device that can, with one click on the pointing device, place a cursor not visible on the screen at the START button in an operating system having a Windows® environment;

(5) to provide a computer pointing device that speeds up a user's ability to locate and control the cursor;

(6) to provide a computer pointing device that is easier and more convenient to use than prior art devices;

(7) to provide a computer pointing device that protects the privacy of sensitive content on the computer screen;

(8) to provide a computer pointing device that allows the user to quickly remove from the screen sensitive content by speeding up the user's ability to minimize the screen containing such content;

(9) to provide a computer pointing device that allows the user to more quickly move child windows that are open on the screen;

(10) to provide a computer pointing device that allows the user to more quickly manipulate child windows that are open on the screen;

(11) to provide a computer pointing device that can, with only one click on the pointing device, move the cursor instantly to a minimize box of a window open on the computer screen;

(12) to provide a computer pointing device that can, with only one click of the device, navigate between the minimize buttons of several simultaneously opened windows by moving the cursor from the minimize box of the most-recently opened window on the screen to the minimize box of the next most recently opened window on the screen;

(13) to provide a computer pointing device that can, with only one click of the device, jump a computer screen from the foreground to a position behind a screen in the foreground;

(14) to provide a computer pointing device that can, with only one click of the device, jump a computer screen to the foreground from a position behind a screen in the foreground;

(15) to provide a computer pointing device that can, with only one click of the device, navigate between the several child windows open on a screen in cascade format by constantly jumping the child window in the foreground to a position behind all other open child windows;

(16) to provide a computer pointing device that can move the cursor with one button click to the minimize button whether there are single or multiple windows on the screen;

(17) to provide a computer pointing device that can move a cursor with one click of a button to the minimize box of a child window whether the multiple child windows on the screen are arranged in tile format or in cascade format; and

(18) to provide a computer pointing device that can move a cursor with one click of a button from the minimize box of a child window to the minimize box of another child window whether the multiple child windows on the screen are arranged in tile format or in cascade format.

### BRIEF DESCRIPTION OF THE DRAWINGS

FIG. 1 is a perspective view of a computer mouse of the prior art;

FIG. 2 is a perspective view of a computer mouse of the present invention showing the new buttons;

FIG. 3a is a perspective view of a computer monitor connected to a computer mouse of the present invention and displaying a website wherein the cursor is not visible on the computer screen;

FIG. 3b is a perspective view of a computer monitor connected to a computer mouse of the present invention and displaying a website wherein the cursor is at the “START” button at the lower-left corner of the computer screen;

FIG. 4a is a perspective view of a computer monitor connected to a computer mouse of the present invention and displaying a website wherein the cursor is visible at a random point of the computer screen;

FIG. 4b is a perspective view of a computer monitor connected to a computer mouse of the present invention and displaying a website wherein the cursor is visible at the “minimize” box of the most-recently opened window displayed on the computer screen;

FIG. 5a is a perspective view of a computer monitor connected to a computer mouse of the present invention, the computer monitor displaying three windows in tile format and wherein the cursor is visible at the random point on the computer screen;

FIG. 5b is a perspective view of a computer monitor connected to a computer mouse of the present invention, the computer monitor displaying three windows in tile format and wherein the cursor is visible at the minimize box of the most recently opened child window;

FIG. 5c is a perspective view of a computer monitor connected to a computer mouse of the present invention, the computer monitor displaying three windows in tile format and wherein the cursor is visible at the minimize box of the second most recently opened child window;

FIG. 5d is a perspective view of a computer monitor connected to a computer mouse of the present invention, the computer monitor displaying three windows in tile format and wherein the cursor is visible at the minimize box of the third most recently opened child window;

FIG. 5e is a perspective view of a computer monitor connected to a computer mouse of the present invention, the computer monitor displaying three windows in tile format and wherein the cursor is not visible on the screen at all;

FIG. 6a is a perspective view of a computer monitor connected to a computer mouse of the present invention, the monitor displaying three windows in cascade format where the cursor is visible at a random point on the screen;

FIG. 6b is a perspective view of a computer monitor connected to a computer mouse of the present invention, the monitor displaying three windows in cascade format where the cursor is situated at the minimize box of the most recently opened window;

FIG. 6c is a perspective view of a computer monitor connected to a computer mouse of the present invention, the monitor displaying three windows in cascade format where the second-most-recently opened child window is in the foreground and the cursor is situated at the minimize box of the second-most-recently opened window;

FIG. 6d is a perspective view of a computer monitor connected to a computer mouse of the present invention, the monitor displaying three windows in cascade format where the third-most recently opened child window is in the foreground and the cursor is situated at the minimize box of that third-most-recently opened window;

FIG. 6e is a perspective view of a computer monitor connected to a computer mouse of the present invention, the monitor displaying two child windows in cascade format where the cursor is situated at the minimize box of the most recently opened window; and

FIG. 7 is a block diagram of the elements of the present invention in the context of its computer hardware and software.

### DETAILED DESCRIPTION OF THE PREFERRED EMBODIMENT

The apparatus and method of the present invention will now be illustrated by reference to the accompanying drawings. In the context of an apparatus, the improved computer pointer device of the present invention has been assigned reference numeral 10. Other elements have been assigned the reference numerals referred to below.

A user of the device 10 of the present interfaces with the computer 100 through the pointing device 10 and the keyboard 110 and by observing the computer monitor 120. Generally, the device 10 is connected to a computer to control movement of a cursor on a computer screen of a computer monitor, the computer monitor also being controlled by the computer. Monitor 120 is electrically connected to computer 100 which has operating system software in a WINDOWS® environment. Monitor 120 refers to any LCD screen used by a computing device to display things and also includes any screen used by a computing device that is not an LCD but accomplishes the same function as an LCD screen.

Computer 100 is also typically linked to the Internet and the world wide web. In alternative embodiments, computer 100 need not be connected to the Internet and can be performing simple word-processing functions. The present invention contemplates any computer that requires or that makes use of a computer pointing device.

Although the description of the preferred embodiments of the present invention describe the method and system and apparatus of the present invention in the context of a computer that has a Windows® operating system, for example when the description refers to cursor 67 as being moved to the START button 66, the present invention fully contemplates having computer pointing devices that operate in the context of a MacIntosh® operating system or in the context of any other suitable operating system environment.

The computer pointing device 10, in one preferred embodiment, is a two-button computer mouse that is popular and widely used and contains a left button and a right button with a scrolling wheel between them. The shape of the computer mouse is irrelevant. The left button 22 is accessed by pushing down on a surface that is referred to herein as the top left click surface 20 and the right button 32 is activated by pushing down on the surface called the top right click surface 30.

In the context of a computer mouse, carved out of the surface area of the top left click surface 20 is a first button 22 located preferably at the upper right portion of top left click surface 20. Carved out of the surface of the top right click surface 30 is a second button 32 located preferably at the upper left portion of top right click surface 30. Thus, left button 22 is part of top left click surface 20 and right button 32 is part of top right click surface 30. Although in a preferred embodiment, the first additional button that commands the movement of the cursor 67 to the START button 66 is on the left and the second additional button that moves the cursor to the minimize boxes of the windows is on the right, the present invention also contemplates the opposite arrangement—first button 22 is on the right and second button 32 is on the left. In fact, the present invention contemplates all other variations in alternative embodiments since this is not absolutely critical.

More generally, the computer pointing device 10 of the present invention, whether it is a computer mouse or other computer device, has a surface 16 with which a user interacts in order to control movement of the cursor that is visible on the computer screen. It is of course understood that the term “cursor” is a broad term that is independent of the shape of the “cursor” and refers to any digital pointer on the screen of a computer that is manipulated by a computer pointing device.

The device 10 of the present invention has a first button 22 and a second button 32 on this surface. The first button 22, when triggered, instantly moves the cursor from a position not visible on the computer screen to a position that is visible on the screen. In particular, the cursor is moved to the lower left portion of the screen. Specifically, the cursor 67 is moved to the START button 66 of a WINDOWS® operating system. Typically, this means that the cursor 67 is moved to the low left hand portion of the computer screen instantly when the first button 22 is activated/pressed. The present invention also contemplates instances where the START button 66 can be located other than at the lower left hand corner of the screen.

More generally, the present invention contemplates that the depressing or pressing or activation or triggering of a first button 22 on the computer pointing device will instantly move the cursor from a point not visible on the computer screen to a defined point or area or “field” on the computer screen. Although in a preferred embodiment, this defined area is the START button 66, in other embodiments of the present invention it is easily imagined that the area can be other defined areas of the screen. The defined areas are preferably areas enabling the user to initiate a screen function. In particular, it is noted in this context that a computer screen is divided digitally and invisibly into various fields.

Second button 32 on pointing device 10 is designed to protect the privacy of the contents of the computer screen. Second button 32 allows a user working on a computer screen to more speedily remove the contents of the screen from view by minimizing the computer screen. Instead of having to drag the cursor to the minimize box to accomplish this, the cursor can be jumped directly to the minimize box of the window most recently opened, which is the child window that the user has been viewing and now wants to quickly hide, by a single activation of the second button 32.

The term “child window” as used in this patent application is taken from the multiple-document interface (MDI) terminology but is intended to broadly include any window on a computer screen in any graphical interface environment. It is called a “child window” and not simply a “window” only because typically it is displayed separately within the client area of the application's main window and therefore there can be more than one child window open at a time.

Although the present invention describes in detail how second button 32 can be used to move cursor 67 to the minimize box of a child window or from the minimize box of one child window to the minimize box of another child window, it should be appreciated that in principle, there may presently be or there may in the future be fields within a computer screen that are not exactly a minimize box or do not look exactly like today's minimize box but which function to reduce the size of a computer screen. Accordingly, it is noted that the present invention contemplates having a device 10 include a second button 32 that controls movement of cursor 67 to such a field or from such a field of one child window to such a field of another child window in accordance with the invention. The term “minimize box” should therefore be understood to mean any field on a computer screen that when activated by a cursor serves to reduce the size of the screen. It need not have a “hyphen-like” symbol; it need not be shaped like a box and it need not be in the upper right corner of the screen.

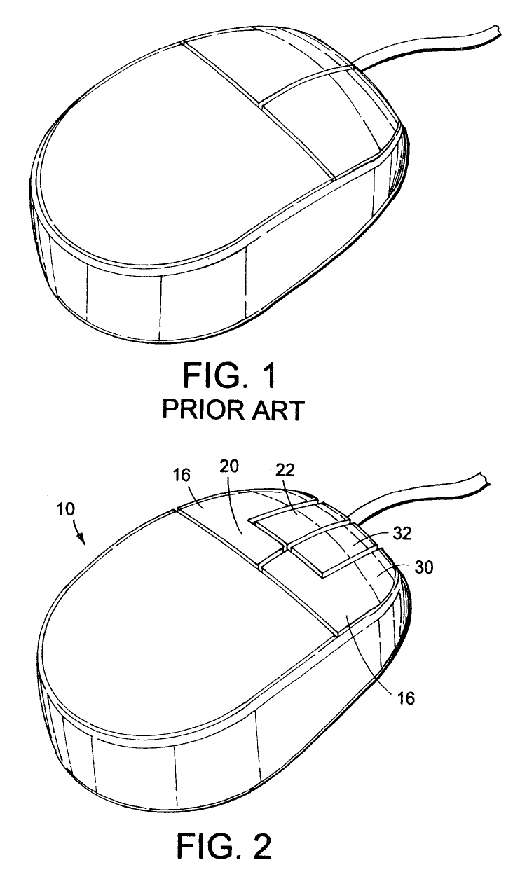

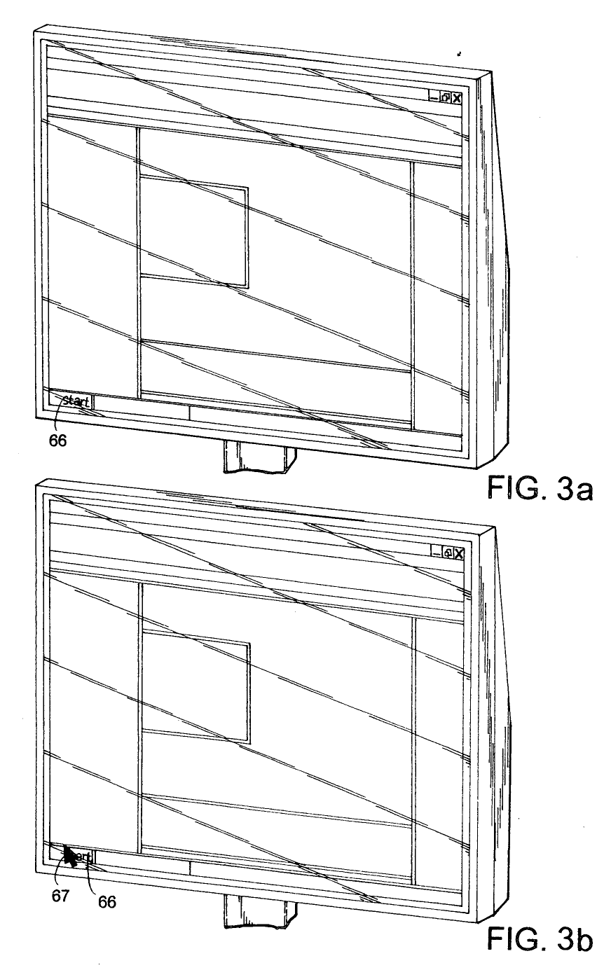

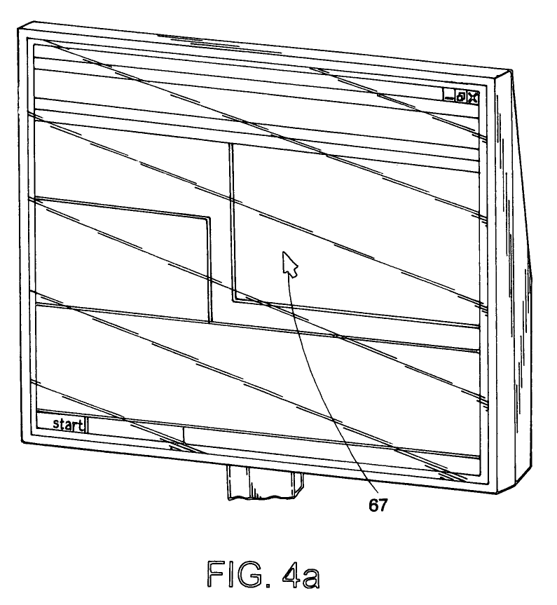

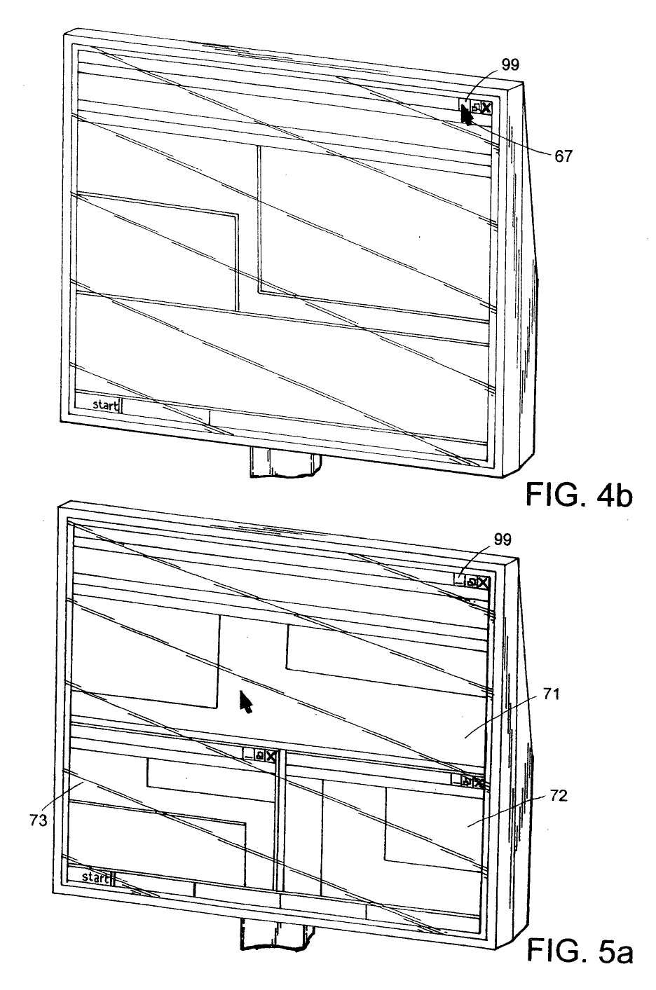

In a general preferred embodiment, second button 32 may be anywhere on device 10. Similarly, first button 22 may be anywhere on device 10. In a more specific preferred embodiment, first button 22 is on the top surface of device 10 and second button 32 is also on the top surface of device 10, in which case both first button 22 and second button 32 can theoretically even be on the same “side” of the top surface of device 10. The top surface is typically the surface that the user interacts with to operate the device. In a further more specific preferred embodiment, first button 22 is on one side of the top surface of device 10 and second button 32 is on a second side of said top surface. In still more specific detail, first button 22 is carved out of a larger left click button area and second button 32 is carved out of a larger right click button area. Finally, in a still more specific preferred embodiment, first button 22 and second button 32 are as shown in FIG. 2, where first button 22 is in a top right portion of the larger left click button area 20 (also called top left click surface 20) of a device 10 (which is a computer mouse 10) and second button 32 is in a top left portion of the larger right click button area 30 (also called top right click surface 30) of device 10. Thus, as shown in FIG. 2, first button 22 and second button 32 are essentially adjacent each other, and are separated by a dividing line dividing into equal halves the most active part 16 of top surface of computer mouse 10. In this context first button 22 may be called left button and second button 32 may be referred to as right button 32.

In cases where the first button 22 moves the cursor to a visible portion of the computer screen, second button 32 moves the cursor, wherever it is, including even cases where the cursor is not visible on the screen, to the minimize box of the most recently opened child window.

In tile format each child window appears in its entirety in the client window. When the child windows are tiled, the system displays each child window in its entirety—overlapping none of the windows. All of the windows are sized, as necessary, to fit within the client window.

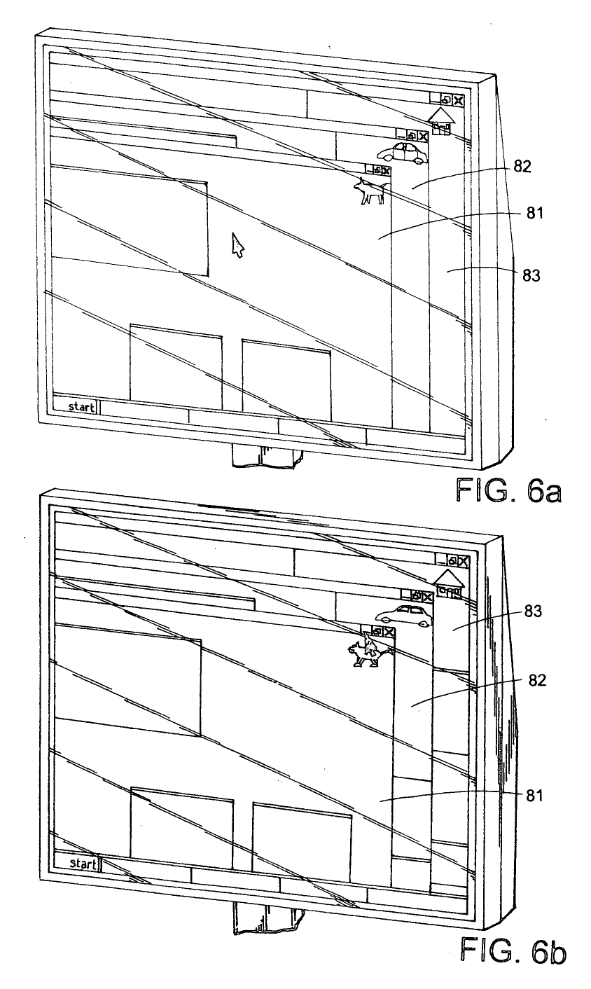

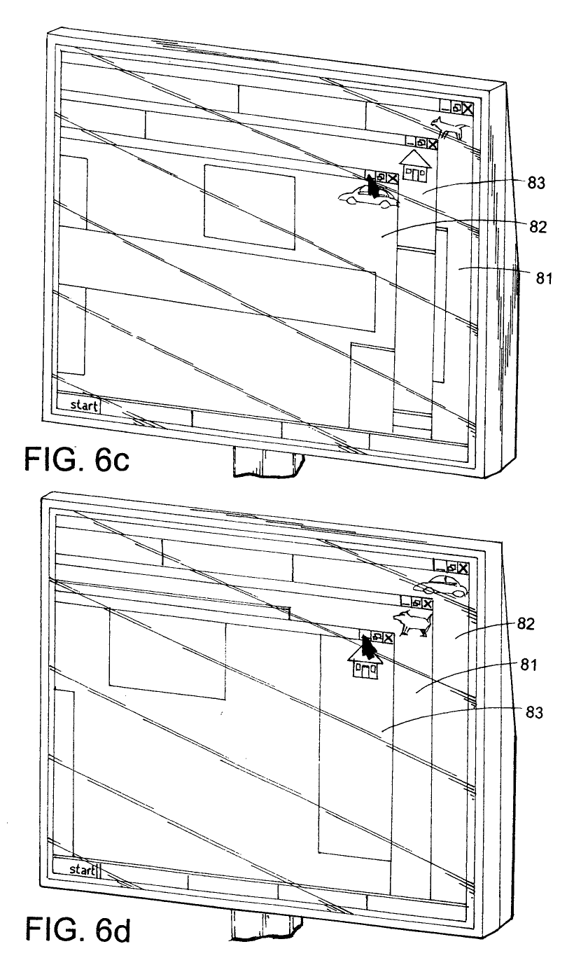

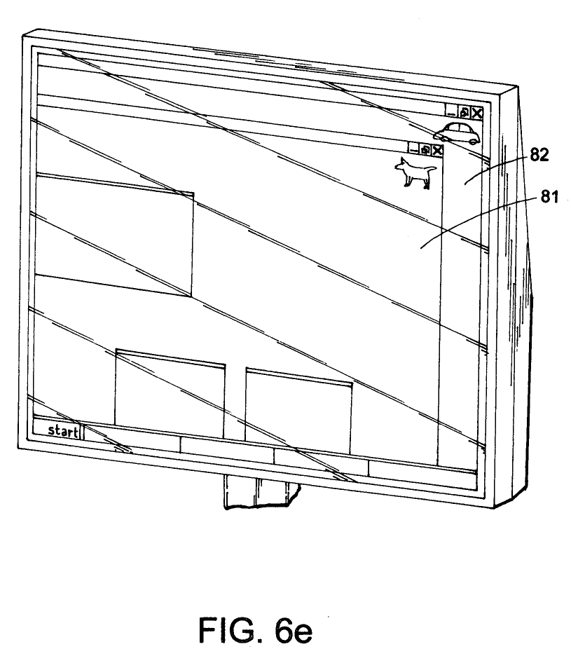

In cascade format, the child windows overlap one another, but the title bar of each of the child windows is visible. When the child windows are cascaded, the windows appear in a stack. The window on the bottom of the stack, by convention, occupies the upper left corner of the screen, and the remaining windows are offset vertically and horizontally so that the left border and title bar of each child window is visible. While this may be the actual convention, the present invention certainly contemplates any format and in fact the drawings in FIGS. 6a-6d show the child windows stacked where the child window on the bottom of the stack occupies the upper right corner (rather than the upper left corner) of the screen. To arrange child windows in the cascade or tile formats, a multiple-document interface application sends a message, typically when the user clicks Cascade or Tile on the window menu.

If several child windows are open, you can also navigate between the windows easier with the second button 32, also called the right button 32. The right button when clicked once, jumps the cursor to the most recently opened window. You can also scroll between the window-minimize buttons of the respective child windows by repeatedly hitting the top right button 32. When multiple child windows are open on the screen in cascade format, each time you hit the right button 32, it jumps the child window in the foreground to the back of the stack of windows and the child window behind the front child window moves to the foreground. Simultaneously, the cursor is instantly located at the minimize box of the new child window in the foreground.

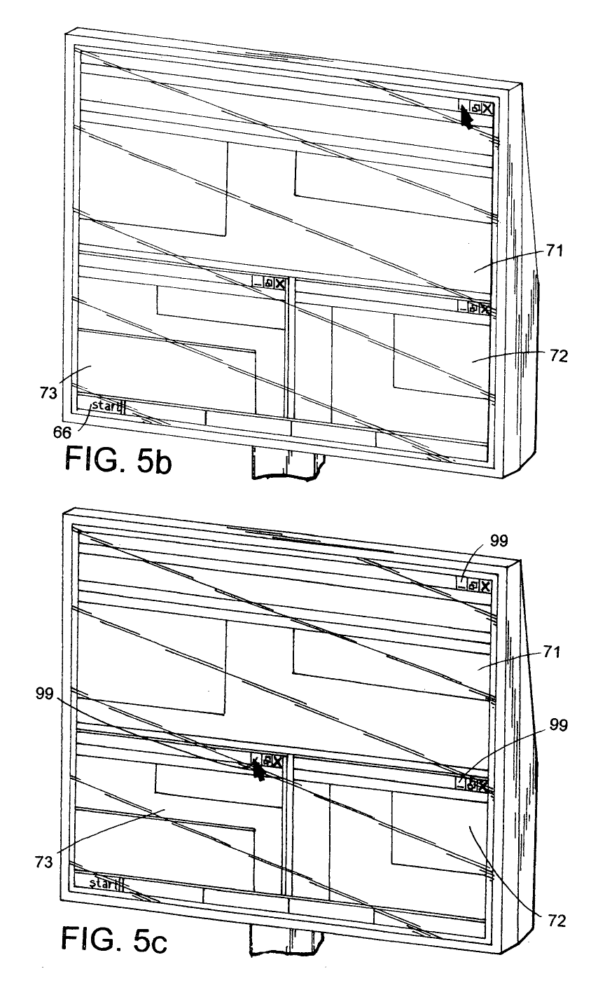

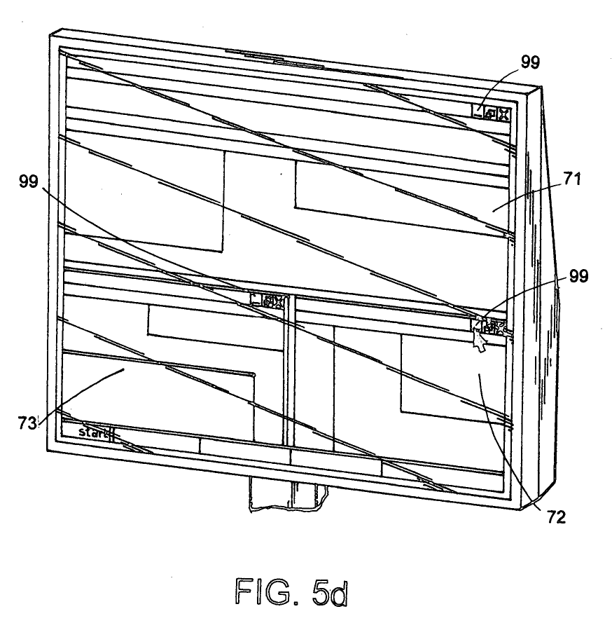

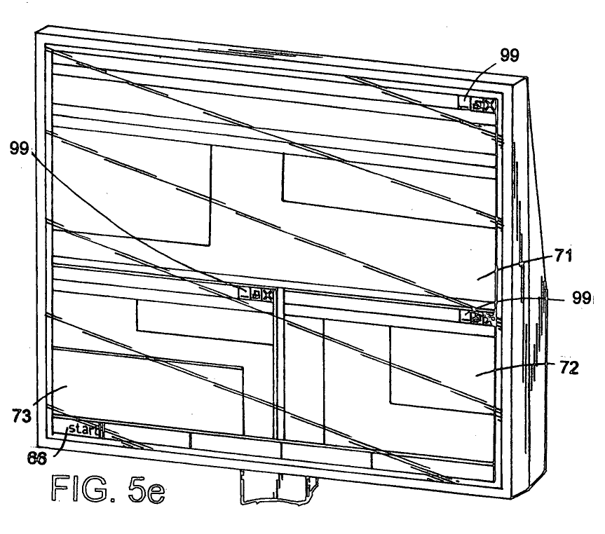

When multiple child windows are open on the computer screen, whether in cascade or tile format, pressing again on the second button instantly moves the cursor to the minimize box of the second most recently opened window. As shown by the progression depicted in FIGS. 5a through 5d, when the cursor is located at the minimize box 99 of an opened window, whether as a result of pressing second button 32 or as a result of ordinary sliding of computer pointing device/mouse 10, then if the child windows—for example child windows 71, 72, 73 of FIG. 5a—are in what is called “tile format”, clicking now on the second button 32 will achieve the result of moving the cursor to the child window that is the next most recently opened child window.

Further pressing on the second button moves the cursor to the minimize box of the third most recently opened child window, and so on. If the number of “presses” on the second button exceeds the number of child windows open, the cycle repeats itself and the cursor reverts to the minimize box of the most recently opened window (if that is where it started). Thus, FIG. 5b represents what happens to the screen in FIG. 5a when the user presses on the second button 32 once. FIG. 5c represents what happens to the screen of FIG. 5b when the user subsequently presses again on second button 32. Finally, FIG. 5c represents what happens to the computer screen of FIG. 5c when the user presses once again on second button 32.

As shown in FIGS. 6a through 6d, if the child windows 81, 82, 83 are in “cascade format”, then pressing the second button 32 when the cursor is already at the minimize box of the child window in the foreground will jump the child window that is in the foreground to the rear-most location in the stack of child windows and place the cursor at the minimize box of the child window that is newly found to be in the foreground. Pressing the second button 32 again at this point would then jump the child window now in the foreground to the rear-most location in the stack of windows and place the cursor at the minimize box of the child window that is again newly found to be in the foreground. The cycle repeats itself if the right button 32 is clicked still further.

Even if the user does not necessarily need to minimize any of the child windows but only wants to move one or more of them, use of the second button 32 speeds up the cursor's placement at the minimize box. Since the minimize box is on or alongside the title bar, whose movement moves the whole window, use of the right button 32 allows enhanced ability to manipulate the child windows.

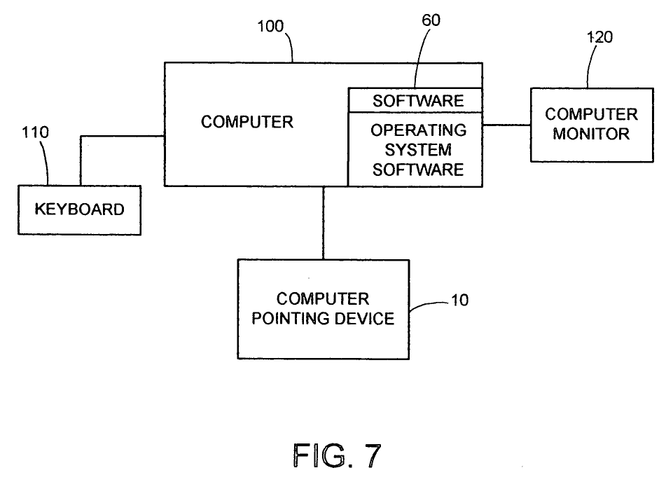

As best illustrated in and appreciated from FIG. 7, the left and right buttons 22, 32 of the computer pointing device 10 of the present invention would be controlled by software 60 that is separate from the operating system software of the computer that the pointing device 10. Software 60 bypasses the functionality of the standard parts of the computer pointing device itself in the sense that the cursor would be controlled directly by the left and right buttons 22, 33 governed by software 60 rather than by the normal left and right buttons of the computer mouse or other pointing device (which normal right and left buttons still remain extant on the computer pointing device of the present invention). In this sense, software 60 would operate much as WINDOWS® shortcuts on the keyboard operate in bypassing the computer pointing device by allowing a user to use the keyboard to perform certain functions. An example of such a shortcut program within the WINDOWS® operating system is pressing ALT-F4, which allows a user to quickly close the screen he or she is working on—in fact the entire program is closed, or at least the entire file document you are working on is immediately closed if multiple documents are open in the word processing program. In contrast to such operating system shortcuts that use the keyboard to bypass the computer pointing device, wherein the software governing such shortcut forms part of the overall operating system of the computer, software 60 of the present invention would not be part of the operating system of the computer that the pointing device 10 of the present invention interfaces with (through the keyboard). Instead, software 60 would have to be installed by the user on top of the operating system.

In one preferred embodiment of the present invention, the invention represents an improvement to a computer pointing device and said software 60 of the improvement to the computer pointing device is located inside separate hardware, such as inside the computer 100 that the computer pointing device connects to. In another preferred embodiment, software 60 would be located in the computer pointing device 10 itself. In this case software 60 would not have to be installed by the user. In either case, the present invention contemplates all ways known to those skilled in the art for configuring the software 60 with the computer pointing device and other hardware.

If the improvement of the present invention is in the context of a track ball computer mouse, the computer mouse itself would have those components that a track ball computer mouse is known to have. These include all the known features of such a mouse including a ball located inside the device and sticking out of the device sufficient to touch a surface external to the device, the ball capable of rolling when the device moves. It would also include a first roller and a second roller inside the device that are capable of rolling when ball rotates, the rollers touching ball, the first roller oriented so that it detects motion in a horizontal direction, the second roller oriented 90 degrees to the first roller. Second roller detects motion in a vertical direction. First roller and second roller are connected to a shaft that spins an optical encoding disk, the disk having holes around an outer edge of the disk. Device would also include an infrared LED and an infrared sensor on each side of the disk. Device 10 includes a processor chip that reads pulses from the infrared sensors and that converts the pulses into binary data and sends the binary data to the computer 100. These internal components of device 10 are not shown in FIG. 2 since they are all well known. The device 10 would also includes an outer surface that includes left click button area 20 and right click button area 30. Likewise, if the improvement of the present invention were an improvement to an optical mouse, the optical mouse would have all known components of an optical mouse, which are discussed in the “Background” section of this patent application. If the improvement of the present invention was in the context of some other kind of computer pointing device, then the device would have the components of such a pointing device.

Although the second button 32 has been described in the context of child windows that are in tile or cascade format, the functionality of button 32 is not limited to these two formats, as those skilled in the art may create and may have created other formats for the appearances of multiple child windows.

The apparatus and method of the present invention contemplate that there be rules under which software 60 controls the effect of the pressing of second button 32. For example, in a preferred embodiment, if five child windows “1” through “5” have been opened in order (first “1”, then “2” etc.) and the second button 32 has been pressed multiple time to the point where it is on the minimize box of child window 5, if then child windows 1 and 3 are closed or minimized, the next pressing of second button 32 will result in the cursor 67 jumping to the minimize box of child window 2 and the following pressing will move the cursor to the minimize box of child window 4.

Similarly, in a preferred embodiment, if five child windows “1” through “5” have been opened in order (first “1”, then “2” etc.) and the second button 32 has been pressed multiple time to the point where it is on the minimize box of child window 5, if then child windows 1, 3 and 4 are closed or minimized and new child window 6 is opened, then the next pressing of second button 32 will result in the cursor 67 jumping to the minimize box of child window 2 and the following pressing will move the cursor to the minimize box of child window 6 and the following pressing will start the cycle again among the windows then open and hence will move the cursor to the minimize box of child window 5.

It is easily appreciated that those skilled in the art can establish different rules for software 60 in regard to the application of the multiple pressings of second button 32. The general principle of the apparatus and method of the present invention is that further pressing of second button 32 jumps the cursor 67 to the most recently opened child window. In certain alternative embodiments, the present invention contemplates exceptions to that general principle.

Described as a method, the present invention comprises vary forms. For example, 10. The present invention may encompass using a pointing device to control movement of a cursor on a computer screen of a computer having operating system software that allows formation of child windows on the computer screen, comprising clicking a first button on the pointing device which clicking causes immediate movement of the cursor from a position not visible on the computer screen to a position visible on the computer screen.

In addition, the present invention may encompass a method of using a pointing device to control movement of a cursor on a computer screen of a computer having operating system software that allows formation of child windows on the computer screen, comprising, comprising clicking on a button on the pointing device which clicking immediately places the cursor onto a “minimize” box of a most-recently opened first child window.

Furthermore, the present invention may encompass using a pointing device to control movement of a cursor on a computer screen of a computer having operating system software that allows formation of child windows on the computer screen, comprising clicking a first button on the pointing device which clicking causes immediate movement of the cursor from a position not visible on the computer screen to a position visible on the computer screen and in addition, clicking on a second button on the pointing device wherein said clicking on the second button immediately places the cursor onto a “minimize” box of a most-recently opened first child window.

This formulation of the method of the present invention may also include clicking a second time on the second button wherein said clicking the second time of said second button immediately places the cursor onto the minimize button of a second-most-recently child window. Furthermore, the method can include the step wherein the first most recently opened child window and the second most recently child window are in cascade format and wherein said clicking the second time of said second button also causes the first most recently opened window to jump behind the second most recently opened child window.

The method can also include clicking a third time on the second button wherein said clicking the third time of said second button immediately places the cursor onto the minimize button of a third-most-recently child window. In certain further embodiments, the first most recently opened child window, the second most recently child window and the third most recently opened child window are in cascade format and said clicking the second time of said second button also causes the first most recently opened window to jump behind the second and third most recently opened child windows and wherein said clicking the third time of said second button also causes the second most recently opened window to jump behind the third and first most recently opened child windows.

Although the apparatus and method of the present invention, as described, involve activation of the first button 22 and the second button 32 by a human user, there is no reason why the user also cannot be a non-human user such as a robot or a computer.

It is to be understood that while the method and apparatus of the present invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. An improvement for a computer pointing device, the computer pointing device of the kind that controls movement of a cursor on a computer screen of a computer, the computer having operating system software that allows formation of child windows on the computer screen, the improvement comprising:
a first button on the pointing device that when activated triggers immediate movement of the cursor from a position not visible on the computer screen to a position visible on the computer screen,
a second button on the pointing device that when activated triggers immediate placement of the cursor on a minimize box of a most-recently opened child window,
software separate from the operating system software,
said software allowing activation of the first button to trigger a communication directly to the operating system software and thereby bypass a cursor-movement-control function that a portion of the computer pointing device other than said improvement normally performs, and
said software allowing activation of the first button to trigger a communication directly to the operating system software and thereby bypass a cursor-movement-control function that a portion of the computer pointing device other than said improvement normally performs.

2. The improvement of claim 1, wherein either the first button is in a left click button area of the computer pointing device and the second button is in a right click button area of the computer pointing device or else the first button is in the right click button area of the computer pointing device and the second button is in the left click button area of the computer pointing device.

3. The improvement of claim 1, wherein the position visible on the computer screen is a defined area of the computer screen allowing a user to initiate a screen function.

4. The improvement of claim 1, wherein the position visible on the computer screen is the lower-left corner of the screen.

5. The improvement of claim 4, wherein the position visible on the computer screen is a location of a “START” button in a graphical interface environment.

6. The improvement of claim 3, wherein the position visible on the computer screen is a location of a “START” button in a graphical interface environment.

7. The improvement of claim 3, wherein either the first button is in a left click button area of the computer pointing device and the second button is in a right click button area of the computer pointing device or else the first button is in the right click button area of the computer pointing device and the second button is in the left click button area of the computer pointing device.

8. The improvement of claim 7, wherein the first button is in the left click button area and the second button is in the right click button area.

9. The improvement of claim 2, wherein the first button is in the left click button area and the second button is in the right click button area.

10. The improvement of claim 1, wherein the second button, if clicked a second time, immediately places the cursor onto a minimize box of a second most recently opened child window.

11. The improvement of claim 10, wherein the first most recently opened child window and the second most recently child window are in cascade format and wherein the second button, when clicked a second time, also causes the first most recently opened window to jump behind the second most recently opened child window.

12. The improvement of claim 10, wherein the second button, if clicked a third time, immediately places the cursor onto a minimize box of a third most recently child window.

13. The improvement of claim 12, wherein the first most recently opened child window, the second most recently child window and the third most recently opened child window are in cascade format and wherein clicking the second time on said second button also causes the first most recently opened window to jump behind the second and third most recently opened child windows and wherein clicking the third time on said second button also causes the second most recently opened window to jump behind the third and first most recently opened child windows.

14. A method of using a computer pointing device to control movement of a cursor on a computer screen of a computer, the computer having operating system software that allows formation of child windows on the computer screen, the method comprising:
clicking a first button on the computer pointing device which clicking causes immediate movement of the cursor from a position not visible on the computer screen to a position visible on the computer screen.

15. The method of claim 14, wherein the position visible on the computer screen is a defined area of the computer screen allowing a user to initiate a screen function.

16. The method of claim 14, wherein the position that is visible on the computer screen is in the lower-left corner of the screen.

17. The method of claim 16, wherein the position that is visible on the computer screen is a location of a “START” button in a graphical interface environment.

18. The method of claim 15, wherein the position that is visible on the computer screen is a location of a “START” button in a graphical interface environment.

19. A method of using a computer pointing device to control movement of a cursor on a computer screen of a computer, the computer having operating system software that allows formation of child windows on the computer screen, the method comprising:
clicking on a button on the computer pointing device which clicking immediately places the cursor onto a minimize box of a most-recently opened first child window.

20. The method of claim 14, including clicking on a second button on the pointing device wherein said clicking on the second button immediately places the cursor onto a minimize box of a most-recently opened first child window.

21. The method of claim 20, wherein either the first button is in a left click button area of the computer pointing device and the second button is in a right click button area of the computer pointing device or else the first button is in the right click button area of the computer pointing device and the second button is in the left click button area of the computer pointing device.

22. The method of claim 21, wherein the first button is in the left click button area and the second button is in the right click button area.

23. The method of claim 20, wherein the position visible on the computer screen is a defined area of the computer screen allowing a user to initiate a screen function.

24. The method of claim 20, wherein the position that is visible on the computer screen is in the lower-left corner of the screen.

25. The method of claim 24, wherein the position that is visible on the computer screen is a location of a “START” button in a graphical interface environment.

26. The method of claim 23, wherein the position that is visible on the computer screen is a location of a “START” button in a graphical interface environment.

27. The method of claim 21, wherein the position visible on the computer screen is a defined area of the computer screen allowing a user to initiate a screen function.

28. The method of claim 21, wherein the position that is visible on the computer screen is in the lower-left corner of the screen.

29. The method of claim 28, wherein the position that is visible on the computer screen is a location of a “START” button in a graphical interface environment.

30. The method of claim 27, wherein the position that is visible on the computer screen is a location of a “START” button in a graphical interface environment.

31. The method of claim 20, including clicking a second time on the second button wherein said clicking the second time on said second button immediately places the cursor onto a minimize button of a second-most-recently child window.

32. The method of claim 31, wherein either the first button is in a left click button area of the computer pointing device and the second button is in a right click button area of the computer pointing device or else the first button is in the right click button area of the computer pointing device and the second button is in the left click button area of the computer pointing device.

33. The method of claim 32, wherein the first button is in the left click button area and the second button is in the right click button area.

34. The method of claim 31, wherein the position visible on the computer screen is a defined area of the computer screen allowing a user to initiate a screen function.

35. The method of claim 31, wherein the position that is visible on the computer screen is in the lower-left corner of the screen.

36. The method of claim 35, wherein the position that is visible on the computer screen is a location of a “START” button in a graphical interface environment.

37. The method of claim 35, wherein the position that is visible on the computer screen is a location of a “START” button in a graphical interface environment.

38. The method of claim 32, wherein the position visible on the computer screen is a defined area of the computer screen allowing a user to initiate a screen function.

39. The method of claim 32, wherein the position that is visible on the computer screen is in the lower-left corner of the screen.

40. The method of claim 39, wherein the position that is visible on the computer screen is a location of a “START” button in a graphical interface environment.

41. The method of claim 38, wherein the position that is visible on the computer screen is a location of a “START” button in a graphical interface environment.

42. The method of claim 31, wherein the first most recently opened child window and the second most recently child window are in cascade format and wherein said clicking the second time on said second button also causes the first most recently opened window to jump behind the second most recently opened child window.

43. The method of claim 31, including clicking a third time on the second button wherein said clicking the third time on said second button immediately places the cursor onto a minimize box of a third most recently child window.

44. The method of claim 43, wherein the first most recently opened child window, the second most recently child window and the third most recently opened child window are in cascade format and wherein said clicking the second time on said second button also causes the first most recently opened window to jump behind the second and third most recently opened child windows and wherein said clicking the third time of said second button also causes the second most recently opened window to jump behind the third and first most recently opened child windows.
